(19) United States
(12) Patent Application Publication
(10) Pub. No.: US 2020/0005342 A1
(43) Pub. Date: Jan. 2, 2020

(54) METHOD AND SYSTEM FOR TICKET-BASED MARKETING ANALYTICS

(71) Applicants: Robert V. Kujawa, JR., Franklin, WI (US); James A. Bischmann, Waukesha, WI (US)

(72) Inventors: Robert V. Kujawa, JR., Franklin, WI (US); James A. Bischmann, Waukesha, WI (US)

(21) Appl. No.: 16/486,089

(22) PCT Filed: Feb. 14, 2018
(86) PCT No.: PCT/US2018/018199

§ 371 Date: Aug. 14, 2019

Related U.S. Application Data
(60) Provisional application No. 62/459,280, filed on Feb. 15, 2017.

(51) Int. Cl. G06Q 30/02; G06F 16/25

(52) U.S. Cl. CPC G06Q 30/0203; G06Q 30/0281; G06Q 30/0201; G06F 16/252

(57) ABSTRACT

The present system and method allow an event holder to gather marketing information from event attendee ticket holders. Each attendee's ticket is scanned to determine the attendee's seat number or ticket number. The system then prompts the attendee to enter personal information through a user interface. All information collected from the attendee is correlated with the attendee's seat number or ticket number in real time and transmitted, again in real time, to at least one customer relationship management database. The system then transmits, in real time, at least one communication to the attendee using the information collected to verify information accuracy.

### CROSS-REFERENCES TO RELATED APPLICATIONS

This application claims the benefit of prior-filed, co-pending U.S. Provisional Patent Application No. 62/459,280, filed on Feb. 15, 2017, the contents of which are incorporated herein by reference in their entirety.

### BACKGROUND OF THE INVENTION

The present invention relates to a marketing research and analysis system, and more specifically, to a marketing research and analysis system offering incentives for a user to provide their personal information.

Data analytics provide crucial information to target marketing efforts. If certain events draw crowds with a particular composition, marketing efforts can focus on that segment of the population if businesses want to increase sales in that segment, or focus on other portions of the population if businesses want to increase diversity. Consumers can receive incentives to encourage them to purchase admission to events on “slow days” with historically low attendance. Sports venues may wish to track the proportions of “home” attendees to determine the effectiveness of local media campaigns. Concert venues may wish to book and market lesser-known performers based on attendees' demonstrated musical tastes.

Businesses with ticket-based admission such as, but not limited to, sports franchises, consumer shows, and entertainment venues have increasingly recognized that their current marketing and information-gathering systems for ticket holders may provide incomplete information. In medium- or large-sized venues especially, such as, but not limited to, large trade shows, major concerts, national conventions, or major sporting events, real time manual information collation, verification, and comparison is impossible, leading to loss of marketing opportunities. Seasonal tickets loaned to an acquaintance or tickets purchased in a block for resale or as gifts do not provide accurate information on the ultimate ticket user. For example, when a person purchases a block of five tickets for a baseball game, are these tickets for acquaintances who will probably have similar interests and socioeconomic status, or for their spouse and children who may have very different interests?

Simply requesting information from consumers is generally ineffective, as recent privacy concerns have decreased consumers' willingness to provide information without incentive. Promotional games and contests, where a consumer provides marketing information in return for a chance at a prize, provide such incentive. According to the Promotions Marketing Association, in previous years American companies spent $1.87 billion on promotional games and contests. Promotional games and contests provide the same thrill as gambling but without any legal or moral hurdles, and without cost to the consumer. In the present economy, participation in promotional games and contests has grown rapidly.

Marketers are seeking ways to make promotions more effective, more measurable, and more compelling to the consumer. The current economy has caused marketers to rethink their tactics. Traditional methods of advertising such as phone directories, print media, and television are in decline. Traditional promotional methods such as coupons, rebates, games, loyalty programs, and contests do not fully leverage the capabilities of today's information technology. Consumers are increasingly turning to the internet to find information about their wants and needs. Traditional mail-in contests with high fulfillment costs are increasingly giving way to a new generation of promotional games and contests that are web based and linked to specific events.

The present invention ties marketing information acquisition to promotional games based on smart devices.

### BRIEF SUMMARY OF THE INVENTION

One aspect of the present application is a method for gathering marketing information from ticket holders. The first step in the method is typically to scan an event attendee's ticket to determine the event attendee's seat number or ticket number, then prompt the event attendee to enter personal information through a user interface in the next step. Next, the method typically correlates all information collected from the event attendee with the event attendee's seat number or ticket number in real time and transmits, in real time, all collected information to at least one customer relationship management (CRM) database. The method typically then transmits, in real time, at least one communication to the event attendee using the information collected to verify accuracy of the information.

Another aspect of the present application is a system for gathering marketing information from ticket holders. The system typically includes at least one smart device, a processor in communication with the at least one smart device, at least one CRM database, and a non-transient computer readable medium programmed with computer readable code that upon execution by the processor causes the processor to execute the above method.

### BRIEF DESCRIPTION OF DRAWINGS

FIGS. 1a, 1b, and 1c are a flowchart of an exemplary market information method for gathering and analyzing market information from event attendee ticket holders.

FIG. 2 is a diagram of an exemplary market information system for gathering market information from event attendee ticket holders.

### DETAILED DESCRIPTION OF THE INVENTION

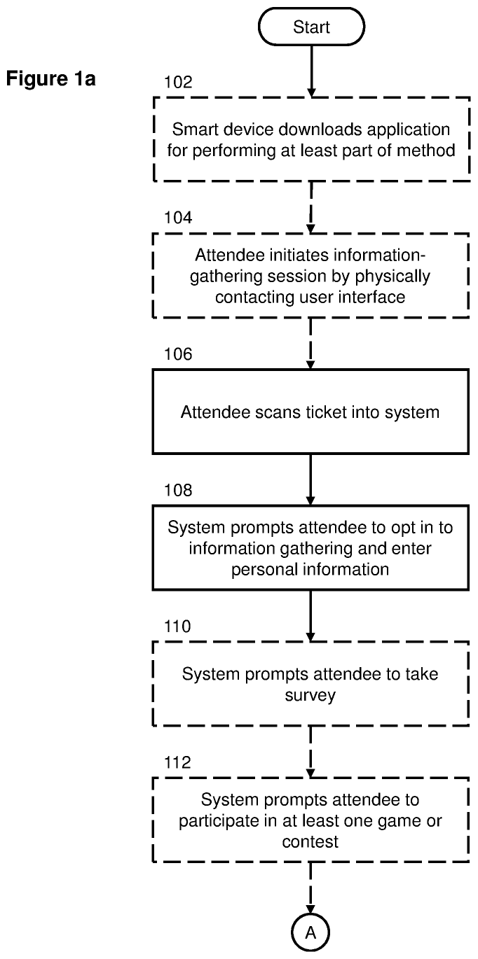

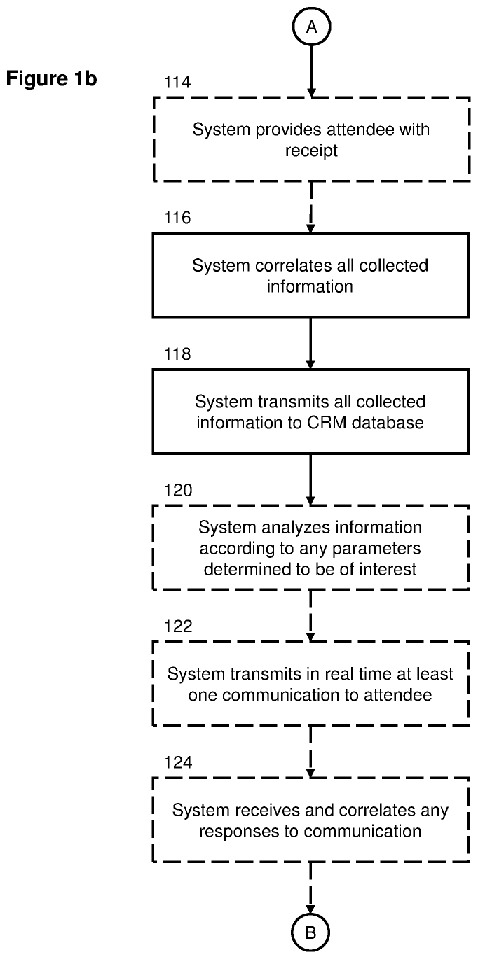

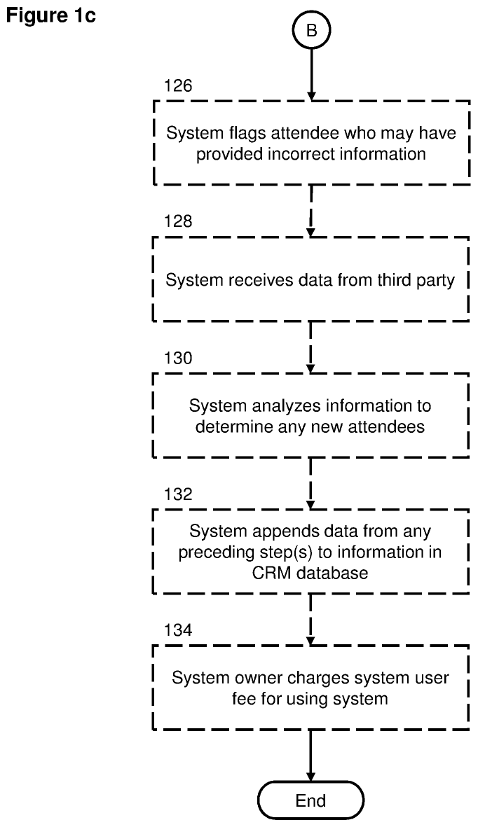

FIGS. 1a, 1b, and 1c are a flowchart of an exemplary market information method 100 for gathering and analyzing market information from event attendee ticket holders. In all venues, such as, but not limited to, major league, minor league, and college sporting events, consumer shows like auto shows, home shows, and boat shows, conventions, concerts and other performing arts events, one challenge typically remains a constant: identifying who is sitting in a seat or who is attending the event. As more and more events are converting to bar coded tickets, a way to assist with identifying who is attending an event is necessary. In one aspect, the present method identifies the attendees with custom software that runs at least partially on smart phones, tablets, and onsite kiosks.

By way of non-limiting example, most of the fans attending a sporting event at the major, minor, and collegiate level are typically not in a sport team's database. Walk up fans, fans attending as part of a group, or employees of a company providing single-event or corporate season tickets to their workers are never identified. Accurate information is typically a sought-after and highly prized commodity for building a customer relationship management (CRM) database. In another aspect, the present method 100 provides that information, using a ticket scan to tie accurate attendee information to the ticket in the attendee's hand, using various prize levels as an inducement.

In another aspect, attendees of an event who wish to participate opt in before or after the ticket scan to begin the process. Attendees typically have one or more ways to participate. One aspect of method 100 is typically performed using a kiosk with an incorporated touchscreen, tablet, or computer. Another aspect typically performs method 100 on a smartphone using a downloaded application. Either way, their information is collected and matched to the ticket to see if they are part of a group, a walk up for that event, and/or part of a season ticket package. With each event having assigned seating, the tickets reset for the new person sitting in the seat. Attendee information goes to the CRM database to see if the ticket holder is already on file. If not, their information is then sent to the ticket issuer as a new opt-in member of their CRM database. If the attendee is already on file, their information may be updated or corrected, or help to build a profile of the attendee's activities.

The incentive for correct information is typically the level of prizes that are offered. Each ticket has the ability to be the winner of a small value prize from a sponsor, the ticket issuer itself, or a large “grand” prize. The ticket holder is typically provided with a chance for the grand prize or a wide variety of prizes such as, by way of non-limiting example, merchandise, ticket offers, cash, prizes from sponsors, or a chance at being selected to participate in a scoreboard game to win a large prize, such as, but not limited to, up to a million dollars or a new vehicle.

Contests can include, by way of non-limiting example, a random draw contest or an instant win contest. Games can include, by way of non-limiting example, a skill- or knowledge-based single-player game, or a skill- or knowledge-based competition between multiple players. Games and contests may be tailored to the setting, such as, but not limited to, a baseball trivia game at a major league baseball game, or a racing game at a car show. The contest may also include random seat number draws using only those seats that are occupied to ensure a contest winner and increase interest in the contests. The game or contest may take place before, during, or after the event, or during the attendee's use of the system.

In addition to the ticket scan, posted QR or other barcodes are typically available for attendees to scan with a smart device. Scanning these codes in the smart device takes the attendees to the appropriate site to enter their information. Since the information collection is typically reset for every event with new or follow-up surveys, the information collected becomes a valuable asset to the ticket issuer to communicate with their marketing base while keeping the CRM database fresh and up to date. Once an attendee is in the CRM database, subsequent ticket scans may trigger a message to the attendee. By way of non-limiting example, the system may welcome the attendee back or wish them good luck in a game or contest. In one aspect, the attendee's e-mail is the identifier field for the CRM database. Once a ticket has been scanned for an event, the seat will typically be identified to that attendee.

Management of consumer events are typically always looking at ways to capture attendee information as well as survey attendees. Like in the sporting event application, a bar-coded ticket typically is the vehicle to gather information by providing a reward for the attendees to participate. The ticket will typically identify the ticket holder, provide any survey information, and have the ability for the attendee to win various prizes, such as, but not limited to, one of several small prizes, a grand prize, or a chance at winning a large valued prize. As stated above, smart devices scan barcodes and/or QR codes from show tickets, event signage, or promotional items for entry into the CRM database of the event. Attendees typically have the option to use custom kiosks or a smart phone app to enter information or codes on display at events. Such information may be added into the CRM database, both to provide a record of attendance or items of interest for the attendee and to update the attendee's information in the CRM database.

The steps of method 100 may be performed out of order or repeated; for example, if a user does not opt in to provide an email address in step 108, but requests that an electronic receipt be emailed in step 114, the system may return to step 108.

Referring to FIG. 1a, in optional step 102, a smart device downloads an application for performing at least part of method 100.

In optional step 104, an attendee initiates an information-gathering session by physically contacting a touch screen or another user interface.

In step 106, an attendee utilizes a scan function of the system to scan the attendee's ticket into the system. This allows the system to determine the attendee's seat number or ticket number, and registers the ticket with the system, preventing ticket reuse. The ticket may have a one- or two-dimensional barcode, or any other type of scan-enabled ticket identification. In aspects that do not use step 104, step 106 initiates method 100.

In step 108, the system prompts the attendee to opt in to information gathering and enter personal information through the user interface. This information may include an attendee's name, email address, phone number, address, age, income, profession, employer, or any other identifying or contact information. The attendee may be influenced to opt in by an offer of being allowed to enter a contest, play a game, or any other inducement that can be displayed by the system.

In optional step 110, the system prompts the attendee to take a survey, answering survey questions through the user interface. The survey may include questions as to general and specific event attendance information, consumer or personal preferences or habits, or any other marketing information an organization or business may require. These questions may be interdependent to ensure that the survey does not waste time asking unnecessary or useless questions. By way of non-limiting examples, an attendee without a car is not asked questions about their driving habits and an underage attendee is not asked about their preferred brand of alcoholic beverage. Previous implementations of method 100 may also determine the questions asked by the survey, to ensure that a user is not asked the same questions or to follow up on marketing outcomes from previous instances of method 100. The attendee may be influenced to answer survey questions by an offer of being allowed to enter a contest, play a game, or any other inducement that can be displayed by the system.

In optional step 112, the system prompts the attendee to participate in at least one contest or play a game for a prize if the attendee opted-in to information collection in a previous step. The contest or game may be selected by the event attendee or selected by the system based on information collected from steps 108 and/or 110. By way of non-limiting example, method 100 might not offer the employee of a promotion sponsor the opportunity to enter their employer's promotion, or allow an underage attendee to enter a contest sponsored by a distillery. Again, by way of non-limiting example, method 100 would not offer an attendee from another country a contest with a prize linked to a particular location, such as a meal every month for a year from a local restaurant, that would be of little use to the attendee. Method 100 may also select the contest based on the event attendee's previous contest experience. By way of another non-limiting example, a previous winner of a recurring contest may not be presented with the opportunity to enter the contest again until a certain amount of time has passed. The contest or game may be a multi-stage contest or game, with a winner or winners progressing to the next level based on random selection or game score.

Referring to FIG. 1b, in optional step 114, the system provides the attendee with a physical or electronic receipt when their active participation in method 100 is finished.

In step 116, the system correlates all collected information from steps 108-112 with the information collected in step 106, linking the seat or ticket number to the attendee's personal information, survey answers, and game and/or contests information in real time.

In step 118, the system transmits all collected information from steps 106-112 to the CRM database in real time. This allows the business to immediately know who is attending the event, where they are located, their answers to the survey, and what prizes they have won. The business can then use this information to act during the event. The business holding the event or a third-party may own and/or manage the CRM database.

In optional step 120, the system analyzes the information according to any parameters determined to be of interest to the business or an outside marketing firm. Such predetermined parameters may include frequency of attendance, dates and times of attendance, events attended, whether the ticket purchaser was the attendee, who attended from a group of linked tickets, survey-specific parameters, games or contests selected, or any other parameters that allow useful marketing analytics.

In optional step 122, the system transmits at least one communication to the attendee. The communication provides verification of the accuracy of the information gathered in step 108; if the communication is returned or otherwise undeliverable, the other information entered may also be unreliable. The communication may be made in real time, near real time, or delayed. Communications may be email or text messages, and may include a personalized message, a marketing communication, notification of winning or being a finalist in a game or contest, the opportunity to opt out of further communication, and/or any other communication. Non-limiting examples of marketing communications include coupons, retail offers, follow-up surveys, information about similar events that may appeal to the attendee, or chances to enter additional games or contests. The communication may be based upon previous communications or the analysis of step 120. By way of non-limiting example, if an attendee received a coupon in a previous communication, the communication may include a different coupon. By way of another non-limiting example, if an attendee lives within a certain geographical radius of a first retailer, but not a second retailer, the attendee may preferentially receive marketing material from the first retailer.

In optional step 124, the system receives and correlates any responses to the communication. By way of non-limiting example, if the attendee uses a coupon or retail offer, or responds to a follow-up survey, this information is transmitted to the CRM database to continue to build the attendee's profile.

Referring to FIG. 1c, in optional step 126, the system flags an attendee who may have provided incorrect information in step 108 in the CRM database. If the communication made in step 122 is returned or otherwise undeliverable, the other information entered may also be unreliable, resulting in flagging the attendee in the CRM database to bring them to the attention of venue or marketing personnel. In certain aspects, the system may be set to automatically flag predetermined language, such as, but not limited to, obscenities, disparagements, or celebrity names, or to automatically correct predetermined misspellings, such, but not limited to, as “gmial.com” or “yahoo.cpm.” Once the attendee is flagged, venue or marketing personnel may try alternate means of communication or remove them from the CRM database.

In optional step 128, the system receives additional tracking information. Such information may be received from an external information gathering device connected to the system or under control of a third party or, in the case of an attendee with an application-enabled smartphone, from the attendee. The third party may be a vendor, an additional tracking system, or some other means of gathering additional information. The information may include amounts spent by an attendee, items purchased or examined, or stations, booths, or other locations entered or of interest.

In optional step 130, the system analyzes the information and compares it to existing information in the CRM database to determine any new attendees. New attendees may be flagged in the CRM database or singled out to receive communications specific to new attendees.

In optional step 132, the system appends information from any of the preceding steps to the information already existing in the CRM database. If an attendee is already in the CRM database, this step may update or add to their existing information.

In optional step 134, the system owner charges the system user a fee for using the system. In certain aspects, the number of new attendees may be used as the basis for the fee. In certain aspects, the fee may be a per capita fee (per attendee, attendee providing information, or new attendee) or a percentage of the amount spent by the attendees or new attendees in a certain time period.

Additional instances of the attendee providing information using method 100 typically continue to add information to the CRM database, as per step 132. This allows businesses to continue to refine analyses of the attendee's consumer habits and provide feedback as to the effectiveness of marketing efforts. By way of non-limiting example, if communications to the attendee encourage them to support their team by attending on days with historically low attendance and the attendee begins to scan tickets on these days, additional marketing may be unnecessary. If the attendee decreases attendance, the business may send a promotional incentive, such as, but not limited to, a ticket discount or a ticket-and-food package deal.

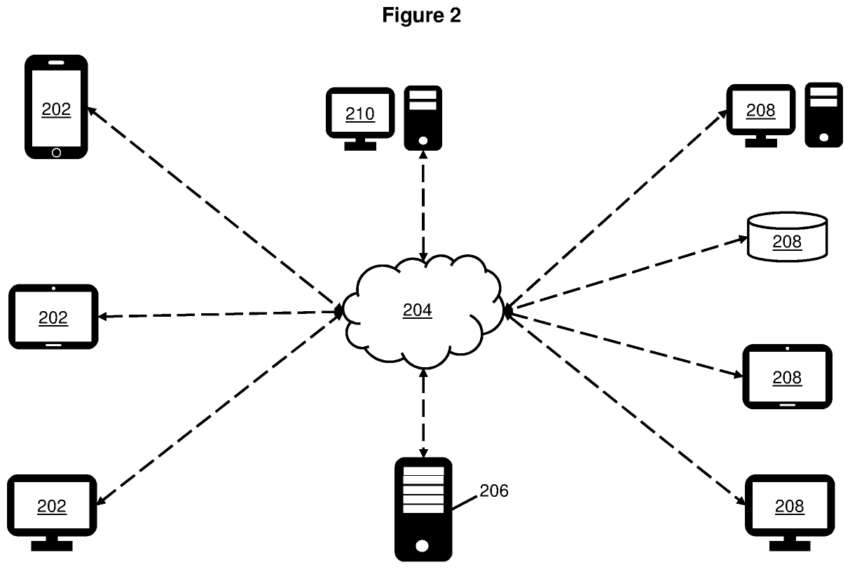

FIG. 2 is a diagram of an exemplary market information system 200 for gathering market information from event attendee ticket holders. System 200 includes at least one smart device 202, data processor 204, CRM database 206, optionally at least one external information gathering device 208, and optionally at least one third-party processor 210.

Smart device 202 is typically a device capable of receiving and communicating information through at least one user interface, such as, but not limited to, a touchscreen, keyboard, scanner, or another user interface. Smart device 202 is also typically capable of transmitting and optionally storing and/or at least partially processing the information. Smart devices are electronic devices, generally connected to other devices or networks via wired or wireless protocols that can operate to some extent interactively and autonomously. Smart device 202 may include a downloaded software application for executing at least part of method 100. Smart device 202 may be incorporated into a kiosk to increase visibility, reduce the likelihood of theft, loss, or damage, and make the device easier to use in a stadium, concert venue, conference center, or other crowded environment. Any other device offering one or more of the above features or functions may likewise be used as smart device 202.

The external information gathering device 208 may also be an individual smart device, or may be another device or system, such as, but not limited to, another market information system 200, a cash register or other point-of-sale device or system, a communications interface between data processor 204 and another system or device, or a computer. In certain aspects, the external information gathering device 208 is capable of receiving information on, analyzing, and reporting marketing offer redemptions and attendee spending patterns. Any other device offering one or more of the above features or functions may likewise be used as external information gathering device 208. Both smart device 202 and external information gathering device 208 are in communication with data processor 204. The connection between smart device 202 and external information gathering device 208, and data processor 204 may be a wired or wireless connection.

The data processor 204 is typically a processor for a cloud-based server. Data processor 204 receives information from at least one smart device 202 and optionally at least one external information gathering device 208. This information may be analyzed, correlated, and/or flagged by data processor 204 and/or stored in CRM database 206. Data processor 204 may be located separately from the CRM database 206 or on the same device.

The data processor 204 can comprise a microprocessor and other circuitry that executes at least part of method 100. Data processor 204 can be implemented within a single processing device but can also be distributed across multiple processing devices or sub-systems that cooperate in existing program instructions. Examples of data processor 204 include general purpose central processing units, application specific processors, and logic devices, as well as any other type of processing device, combinations of processing devices, or variations thereof.

The CRM database 206 may be a single CRM database incorporating information from multiple events or multiple CRM databases, each corresponding to a single event, date, or set of events or dates. CRM database 206 may be located on one or more computers, servers, or any other electronic or memory device(s) capable of receiving and storing information. CRM database 206 can comprise any storage media readable by data processor 204, and capable of storing information. CRM database 206 can include volatile and non-volatile, removable and non-removable media implemented in any method or technology for storage of information, such as, but not limited to, computer readable instructions, data structures, program modules, or other information. CRM database 206 can be implemented as a single storage device but may also be implemented across multiple storage devices or sub-systems. CRM database 206 can further include additional elements, such a controller capable of communicating with data processor 204.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by a user or system, as well as any combination or variation thereof, or any other type of storage medium. In some aspects, the storage media can be a non-transitory storage media. In some aspects, at least a portion of the storage media may be transitory. Storage media may be internal or external to system 200.

The third-party processor 210 is typically a computer, smart device, or other device capable of receiving, validating, analyzing, and/or appending information received from or for CRM database 206. This may allow a third party to use third-party processor 210 to perform at least some of the functions of data processor 204.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

It is understood that the invention is not confined to the particular construction and arrangement of parts herein illustrated and described, but embraces such modified forms thereof as come within the scope of the claims.

1. A method for gathering marketing information from event attendee ticket holders, comprising:
scanning an event attendee's ticket to determine the event attendee's seat number or ticket number;
prompting the event attendee to enter information through a user interface;
correlating all information collected from the event attendee with the event attendee's seat number or ticket number in real time; and
transmitting in real time all collected information to at least one customer relationship management (CRM) database.

2. The method of claim 1, further comprising prompting the event attendee to take a survey by answering survey questions through the user interface.

3. The method of claim 2, wherein the survey questions are dependent upon previously asked survey questions.

4. The method of claim 1, further comprising prompting the event attendee to participate in at least one game or contest.

5. The method of claim 4, wherein the at least one game or contest is selected by the event attendee, selected based on information collected from the event attendee, or selected based on the event attendee's previous game or contest experience.

6. The method of claim 4, wherein the at least one game or contest is chosen from the group consisting of: a random draw contest, an instant win contest, a skill- or knowledge-based single-player game, or a skill- or knowledge-based competition between multiple players, or any combination thereof.

7. The method of claim 4, wherein the at least one game or contest is at least one random seat number draw using only occupied seats.

8. The method of claim 4, wherein the at least one game or contest takes place during or after the event, or during the event attendee's use of the smart device.

9. The method of claim 1, further comprising transmitting at least one communication to the event attendee using the information collected.

10. The method of claim 1, further comprising analyzing the information according to predetermined marketing parameters.

11. The method of claim 1, further comprising receiving and correlating any responses to the at least one communication.

12. The method of claim 1, further comprising flagging an event attendee who may have provided incorrect information in the at least one CRM database.

13. The method of claim 12, further comprising flagging predetermined language or correcting predetermined misspellings

14. The method of claim 1, wherein the event attendee physically contacts the user interface to initiate the method.

15. The method of claim 1, further comprising appending additional information to existing information in the at least one CRM database.

16. The method of claim 1, further comprising comparing the information to existing information in the CRM database to determine any new attendees.

17. The method of claim 16, further comprising calculating a usage fee based on a number of new event attendees in the at least one CRM database.

18. A system for gathering marketing information from event attendee ticket holders, comprising:
at least one smart device;
a data processor in communication with the at least one smart device;
at least one CRM database; and
a non-transient computer readable medium programmed with computer readable code that upon execution by the data processor causes the data processor to execute a method for gathering marketing information from event attendee ticket holders, comprising:
scanning an event attendee's ticket to determine the event attendee's seat number or ticket number,
prompting the event attendee to enter personal information through a user interface,
correlating all information collected from the event attendee with the event attendee's seat number or ticket number in real time,
transmitting in real time all collected information to at least one customer relationship management (CRM) database, and
transmitting in real time at least one communication to the event attendee using the information collected to verify accuracy of the information.

19. The system of claim 18, wherein the smart device includes a downloaded application for performing at least part of the method.

20. The system of claim 18, further comprising at least one external information gathering device or third-party processor in communication with the data processor.
